(19) United States
(12) Patent Application Publication
(10) Pub. No.: US 2024/0231813 A9
(43) Pub. Date: Jul. 11, 2024

(54) SOURCE CODE SUMMARY METHOD BASED ON AI USING STRUCTURAL INFORMATION, APPARATUS AND COMPUTER PROGRAM FOR PERFORMING THE METHOD

(71) Applicant: UIF (University Industry Foundation), Yonsei University, Seoul (KR)

(72) Inventors: Yo-Sub Han, Seoul (KR); HyeonTae Seo, Anyang-si (KR); Jikyeong Son, Seoul (KR); Joonghyuk Hahn, Seoul (KR)

(21) Appl. No.: 18/069,075

(22) Filed: Dec. 20, 2022

(30) Foreign Application Priority Data
Oct. 25, 2022 (KR) 10-2022-0138456

(51) Int. Cl. G06F 8/73; G06F 8/75; G06F 40/284

(52) U.S. Cl. CPC G06F 8/73; G06F 8/75; G06F 40/284

(57) ABSTRACT

According to the source code summary method based on AI using structural information, an apparatus and a computer program for performing the same according to the exemplary embodiment of the present disclosure, the source code is summarized based on the artificial intelligence using the structural information of the source code to propose a neural network model which learns the structural characteristic and meaning of the code by ensembling an encoder which learns a program dependency graph (PDG) and an encoder which learns a code sequence, thereby improving the code summary performance.

### CROSS-REFERENCE TO RELATED APPLICATIONS

This application claims priority to and the benefit of Korean Patent Application No. 10-2022-0138456 filed in the Korean Intellectual Property Office on Oct. 25, 2022, the entire contents of which are incorporated herein by reference.

### BACKGROUND

### Field

The present disclosure relates to a source code summary method based on AI using structural information, an apparatus and a computer program for performing the same, and more particularly, to a method, an apparatus, and a computer program of summarizing a source code. The present patent application has been filed as research projects as described below.

### [1] National Research Development Project Supporting the Present Invention

Project Serial No. 1711159332
Project No.: 2020R1A4A3079947
Department: Ministry of Science and ICT
Project management (Professional) Institute: National Research Foundation of Korea (NRF)
Technology Planning & Evaluation Research Project Name: Basic Research Lab Program
Research Task Name: Human-AI Collaborative Programming Platform Technology Laboratory (3/3)
Contribution Ratio: 1/2
Project Performing Institution: UIF (University Industry Foundation), Yonsei University
Research Period: 2022.03.01˜2023.02.28

### [2] National Research Development Project Supporting the Present Invention

Project Serial No. 1711152718
Project No.: 2020-0-01361-003
Department: Ministry of Science and ICT
Project management (Professional) Institute: Institute of Information & Communication Technology Planning & Evaluation
Research Project Name: Information & Communication Broadcasting Research Development Project
Research Task Name: Artificial Intelligence Graduate School Support Project (3/5)
Contribution Ratio: 1/2
Project Performing Institution: UIF (University Industry Foundation), Yonsei University
Research Period: 2022.01.01˜2022.12.31

### DESCRIPTION OF THE RELATED ART

Recently, deep learning study which generates a summary of source codes tends to learn by reflecting not only sequence type information, but also a structural characteristic of code. To this end, the code is transformed into a structure, such as an abstract syntax tree (AST) or a control flow graph (CFG) to be used for the learning.

Specifically, the abstract syntax tree (AST) is frequently used so that the deep learning model, such as mAST+GCN, CAST, or SiT, has improved the performance compared to the existing study that processes only the sequence. However, the abstract syntax tree (AST) forms overly complex graph structure for a long code so that in this case, the performance of generating the summary is very poor. Further, even though the graph structure is used, the existing technique is lacking in studies on the learning model structure suitable for this.

### SUMMARY

An object to be achieved by the present disclosure is to provide a source code summary method based on AI using structural information which summarizes source codes based on artificial intelligence using structural information of a source code, an apparatus and a computer program for performing the same.

Other and further objects of the present disclosure which are not specifically described can be further considered within the scope easily deduced from the following detailed description and the effect.

In order to achieve the above-described technical objects, according to an aspect of the present disclosure, an AI based source code summary method using structural information includes acquiring a source code and a program dependency graph (PDG) corresponding to the source code; and training a neural network with a source code summary as an output based on the source code and the program dependency graph (PDG).

Here, the neural network includes a first encoder which learns a code sequence based on the source code; a second encoder which learns a structural characteristic based on the program dependency graph (PDG); and a decoder which receives an ensemble of an output of the first encoder and an output of the second encoder to generate the source code summary for the source code.

Here, the first encoder receives a token embedding of a source code and outputs a token-level latent expression of the source code.

Here, the second encoder receives the program dependency graph (PDG) and outputs a statement level latent expression for the source code.

Here, the second encoder uses an attention of a graph edge of the program dependency graph (PDG).

Here, the decoder receives a value connecting a token level latent expression which is an output of the first encoder and a statement level latent expression which is an output of the second encoder and outputs the source code summary formed of natural language summary.

In order to achieve the above-described technical objects, according to an aspect of the present disclosure, a computer program is stored in a computer readable storage medium to allow a computer to execute any one of the above AI based source code summary method using structural information.

In order to achieve the above-described technical objects, according to an aspect of the present disclosure, an AI based source code summary apparatus using structural information includes a memory which stores one or more programs to summary a source code based on the artificial intelligence using structural information of the source code; and one or more processors which performs an operation to summary the source code based on the artificial intelligence using structural information of the source code according to one or more programs stored in the memory, the processor is configured to acquire a source code and a program dependency graph (PDG) corresponding to the source code; and train a neural network with a source code summary as an output based on the source code and the program dependency graph (PDG).

Here, the neural network includes a first encoder which learns a code sequence based on the source code; a second encoder which learns a structural characteristic based on the program dependency graph (PDG); and a decoder which receives an ensemble of an output of the first encoder and an output of the second encoder to generate the source code summary for the source code.

Here, the first encoder receives token embedding of a source code and outputs a token-level latent expression of the source code.

Here, the second encoder receives the program dependency graph (PDG) and outputs a statement level latent expression for the source code.

Here, the decoder receives a value connecting a token level latent expression which is an output of the first encoder and a statement level latent expression which is an output of the second encoder and outputs the source code summary formed of natural language summary.

According to the source code summary method based on AI using structural information, an apparatus and a computer program for performing the same according to the exemplary embodiment of the present disclosure, the source code is summarized based on the artificial intelligence using the structural information of the source code to propose a neural network model which learns the structural characteristic and meaning of the code by ensembling an encoder which learns a program dependency graph (PDG) and an encoder which learns a code sequence, thereby improving the code summary performance.

The effects of the present invention are not limited to the technical effects mentioned above, and other effects which are not mentioned can be clearly understood by those skilled in the art from the following description

### BRIEF DESCRIPTION OF THE DRAWINGS

FIG. 1 is a block diagram for explaining an AI based source code summary apparatus using structural information according to an exemplary embodiment of the present disclosure;

FIG. 2 is a flowchart for explaining an AI based source code summary method using structural information according to an exemplary embodiment of the present disclosure;

FIG. 3 is a flowchart for explaining a structure of a neural network according to an exemplary embodiment of the present disclosure;

FIG. 4 is a view for explaining an example of a learning process of a neural network according to an exemplary embodiment of the present disclosure;

FIG. 5 is a view for explaining an example of a program dependency graph according to an exemplary embodiment of the present disclosure; and

FIG. 6 is a view for explaining an example of a token type of a source code according to an exemplary embodiment of the present disclosure.

### DETAILED DESCRIPTION OF THE EMBODIMENT

Hereinafter, embodiments of the present disclosure will be described in detail with reference to the accompanying drawings. Advantages and characteristics of the present disclosure and a method of achieving the advantages and characteristics will be clear by referring to exemplary embodiments described below in detail together with the accompanying drawings. However, the present disclosure is not limited to exemplary embodiments disclosed herein, but will be implemented in various different forms. The exemplary embodiments are provided by way of example only so that a person of ordinary skilled in the art can fully understand the disclosures of the present invention and the scope of the present invention. Therefore, the present invention will be defined only by the scope of the appended claims. Like reference numerals generally denote like elements throughout the specification.

Unless otherwise defined, all terms (including technical and scientific terms) used in the present specification may be used as the meaning which may be commonly understood by the person with ordinary skill in the art, to which the present invention belongs. It will be further understood that terms defined in commonly used dictionaries should not be interpreted in an idealized or excessive sense unless expressly and specifically defined.

In the specification, the terms “first” and “second” are used to distinguish one component from the other component so that the scope should not be limited by these terms. For example, a first component may also be referred to as a second component and likewise, the second component may also be referred to as the first component.

In the present specification, in each step, numerical symbols (for example, a, b, and c) are used for the convenience of description, but do not explain the order of the steps so that unless the context apparently indicates a specific order, the order may be different from the order described in the specification. That is, the steps may be performed in the order as described or simultaneously, or an opposite order.

In this specification, the terms “have”, “may have”, “include”, or “may include” represent the presence of the characteristic (for example, a numerical value, a function, an operation, or a component such as a part”), but do not exclude the presence of additional characteristic.

Hereinafter, an exemplary embodiment of an AI based source code summary method using structural information, an apparatus and a computer program performing the same according to the present disclosure will be described in detail with reference to the accompanying drawings.

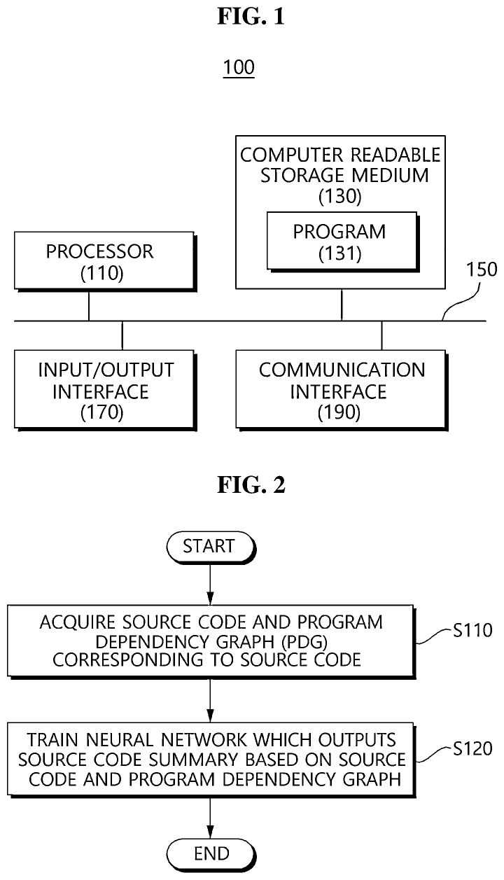

First, an AI based source code summary apparatus using structural information according to an exemplary embodiment of the present disclosure will be described with reference to FIG. 1.

FIG. 1 is a block diagram for explaining an AI based source code summary apparatus using structural information according to an exemplary embodiment of the present disclosure.

Referring to FIG. 1, an AI based source code summary apparatus 100 using structural information according to an exemplary embodiment of the present disclosure (hereinafter, referred to as a source code summary apparatus) summarizes a source code based on artificial intelligence using structural information of the source code.

That is, the source code summary apparatus 100 ensembles an encoder which learns a program dependency graph (PDG) and an encoder which learns a code sequence to propose a neural network model which learns both a structural characteristic and the meaning of the code to improve the code summary performance.

To this end, the source code summary apparatus 100 may include one or more processors 110, a computer readable storage medium 130, and a communication bus 150.

The processor 110 controls the source code summary apparatus 100 to operate. For example, the processor 110 may execute one or more programs 131 stored in the computer readable storage medium 130. One or more programs 131 include one or more computer executable instructions and when the computer executable instruction is executed by the processor 110, the computer executable instruction may be configured to allow the source code summary apparatus 100 to perform an operation for summarizing a source code based on the artificial intelligence using structural information of the source code.

The computer readable storage medium 130 is configured to store a computer executable instruction or program code, program data and/or other appropriate format of information to summarize the source code based on the artificial intelligence using structural information of the source code. The program 131 stored in the computer readable storage medium 130 includes a set of instructions executable by the processor 110. In one exemplary embodiment, the computer readable storage medium 130 may be a memory (a volatile memory such as a random access memory, a non-volatile memory, or an appropriate combination thereof), one or more magnetic disk storage devices, optical disk storage devices, flash memory devices, and another format of storage media which are accessed by the source code summary apparatus 100 and store desired information, or an appropriate combination thereof.

The communication bus 150 interconnects various other components of the source code summary apparatus 100 including the processor 110 and the computer readable storage medium 130 to each other.

The source code summary apparatus 100 may include one or more input/output interfaces 170 and one or more communication interfaces 190 which provide an interface for one or more input/output devices. The input/output interface 170 and the communication interface 190 are connected to the communication bus 150. The input/output device (not illustrated) may be connected to the other components of the source code summary apparatus 100 by means of the input/output interface 170.

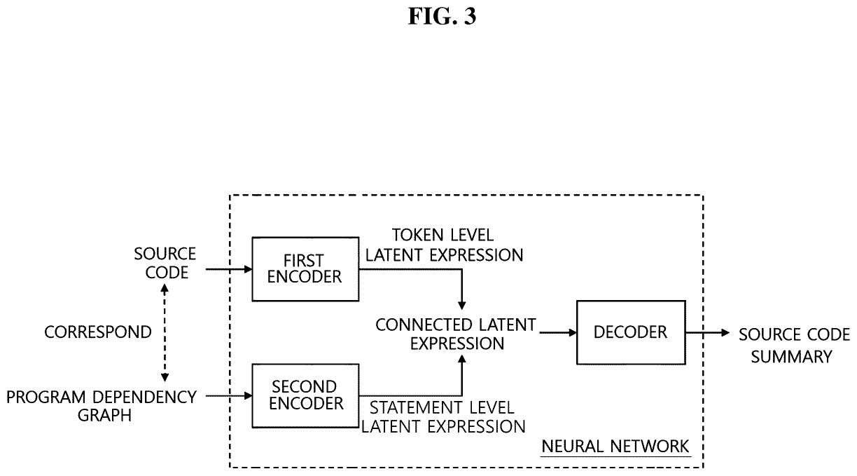

Now, an AI based source code summary method using structural information according to an exemplary embodiment of the present disclosure will be described with reference to FIGS. 2 and 3.

FIG. 2 is a flowchart for explaining an AI based source code summary method using structural information according to an exemplary embodiment of the present disclosure and FIG. 3 is a flowchart for explaining a structure of a neural network according to an exemplary embodiment of the present disclosure.

Referring to FIG. 2, the processor 110 of the source code summary apparatus 100 acquires a source code and a program dependency graph (PDG) corresponding to the source code in step S110.

Thereafter, the processor 110 learns the neural network which outputs a source code summary based on the source code and the source code dependency graph (PDG) in step S120.

Here, the neural network may include a first encoder, a second encoder, and a decoder as illustrated in FIG. 3.

The first encoder learns a code sequence based on a source code.

That is, the first encoder receives token embedding of a source code and outputs a token-level latent expression of the source code.

The second encoder learns the structural characteristic based on a program dependency graph (PDG) corresponding to the source code input to the first encoder.

That is, the second encoder receives the program dependency graph (PDG) and outputs a statement level latent expression for the source code. At this time, the second encoder uses an attention of a graph edge of the program dependency graph (PDG).

The decoder receives an ensemble of an output of the first encoder and an output of the second encoder to generate a source code summary for the source code.

That is, the decoder receives connected latent expression which is a value connecting a token level latent expression which is an output of the first encoder and a statement level latent expression which is an output of the second encoder and outputs a source code summary formed of a natural language summary.

In other words, when the source code and the program dependency graph (PDG) corresponding thereto are input, the processor 110 may train a neural network which outputs a source code summary which is a natural language summary for the source code, based on learning data formed of a plurality of training data. Here, the training data includes a source code, a program dependency graph (PDG) corresponding to the source code, and a correct answer summary corresponding to the source code. That is, the source code of the training data and the program dependency graph (PDG) are used as input values and the correct answer summary of the training data is used as an output value to repeatedly train the neural network based on the training data. After completing the training of the neural network, when a target source code and a program dependency graph (PDG) corresponding thereto are input, the source code summary for the target source code is acquired using the neural network which is trained and constructed.

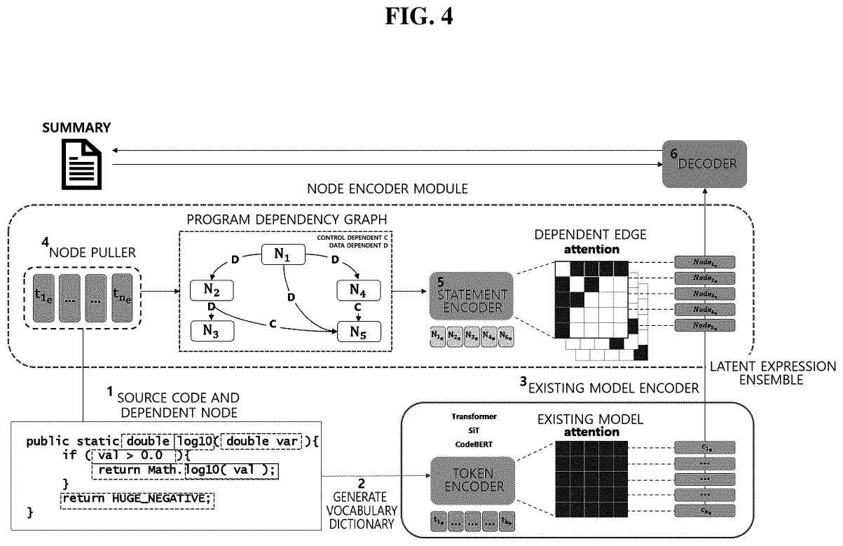

Now, an AI based source code summary method using structural information according to an exemplary embodiment of the present disclosure will be described in more detail with reference to FIGS. 4 to 6.

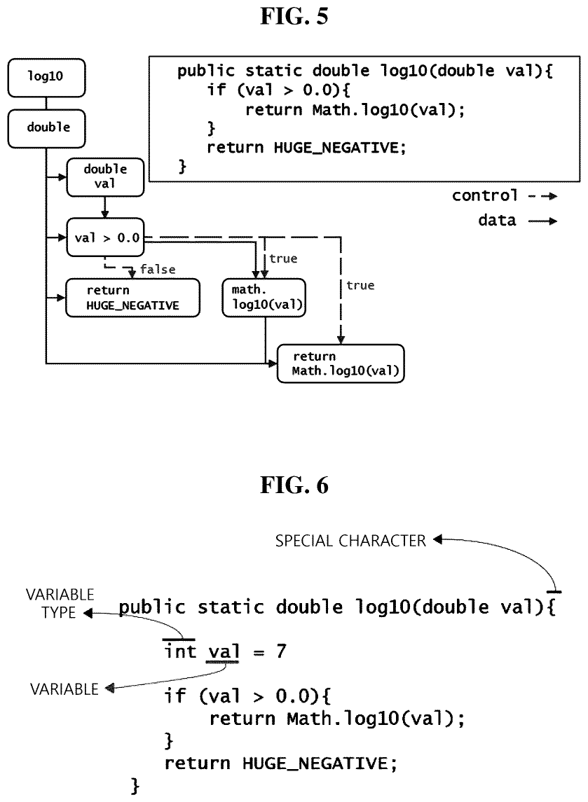

FIG. 4 is a view for explaining an example of a learning process of a neural network according to an exemplary embodiment of the present disclosure, FIG. 5 is a view for explaining an example of a program dependency graph according to an exemplary embodiment of the present disclosure, and FIG. 6 is a view for explaining an example of a token type of a source code according to an exemplary embodiment of the present disclosure.

The source code summary apparatus 100 according to the present disclosure relates to a neural network including a node encoder (that is, a second encoder) which uses a program dependency graph (PDG) considering control flow and data flow and learns a graph structure to overcome the complexity according to the code length of an abstract syntax tree (AST).

That is, the present disclosure proposes a deep learning technique which provides a summary of a program for JAVA and C-language. The present disclosure proposes a node encoder (that is, a second encoder) which uses and learns a program dependency graph (PDG) by paying attention to a structural characteristic of a source code which expresses the program. The present disclosure proposes a deep learning model which provides a natural language summary by ensembling an encoder (that is, a first encoder) which learns a source code sequence and a node encoder (that is, a second encoder) for effective model learning.

Referring to FIG. 4, the present disclosure is a transformer based structural information learning module which helps to receive the source code to output the natural language summary. The existing source code summary automatic models learn the token level source code information, but the module proposed by the present disclosure includes a node encoder module (that is, a second encoder) which learns statement level structural information. The input source code is converted into a one-dimensional vector to be input to the encoder (that is, a first encoder) and a node encoder (that is, a second encoder) and outputs source code token level latent expression and statement level latent expression. The decoder receives outputs of two latent expressions to learn the relationship with the source code and then output a summary.

### 1. Separate Source Code and Generate Program Dependency Graph (PDG) Information

A program dependency graph as illustrated in FIG. 5 is generated according to the data dependency and the control dependency of the source code. Here, the data dependency refers that previously used data affects the other variable. The control dependency refers that a control statement node affects the other variable. The control statement in the source code refers to a function of determining an execution statement according to a given condition.

As illustrated in FIG. 5, the program dependency graph (PDG) for the given source code generates “node information” from which a source code is separated with respect to the generated node. “Edge information” between separated nodes is generated. Thereafter, the edge information is used to perform attention between connection nodes in a statement encoder layer (that is, the second encoder).

### 2. Generate Vocabulary Dictionary of Input Program Source Code and Summary Natural Language Token

As illustrated in FIG. 6, the input program source code is configured by various types of tokens, such as a variable, a variable type, a keyword, a special character, a function, a literal, and a variable. Among them, the variable type and the special character are vocabularies commonly used for different source codes. However, the variable varies according to a designated vocabulary of a programmer. Accordingly, a total number of vocabularies is limited with respect to a maximum frequency of the vocabularies. A reference for extracting a vocabulary from the source code follows a method of an existing model (that is, the first encoder) which is ensembled with the node encoder module (that is, the second encoder).

3. Perform Token Encoder of Existing Model Encoder (that is, the First Encoder)

Even though source code encoding methods of the existing model encoder (that is, the first encoder) are different, token embedding is input to output a token level latent expression. The embedding in the automatic source code summary refers to a result obtained by changing a natural language used by human into a vector which is a number type understandable by the machine. The latent expression refers to an output of a hidden layer in the deep learning.

Notation for an input and an output of the existing model encoder (that is, the first encoder) is as follows. When a length of the source code is m, token embedding oft for a token t=(t₁, t₂, . . . , tₘ) is denoted as tₑ=(t₁ₑ, t₂ₑ, . . . , tₘₑ). Further, the token latent expression learned from the existing token encoder (that is, the first encoder) is denoted as cₑ=(c₁ₑ, c₂ₑ, . . . , cₘₑ). The token latent expression which is finally output is ensembled with the latent expression output of the node encoder (that is, the second encoder).

4. Perform Node Puller by Node Encoder Module (that is, Second Encoder)

A node puller is a function which receives the token embedding of a process 3 to output a node latent expression (1) of the program dependency graph (PDG). The node puller means that the latent expression 1 representing the node is acquired by means of tokens included in the node. In order to obtain the node latent expression 1, token embedding tₑ and node information MASK of a process 1 are given. The following Equation 1 is an equation of a node puller. Node refers to a statement level node of the program dependency graph (PDG) and Node e refers to a latent expression 1 to be output through a function of the node.

First, MASK receives a source code. If the token in the source code is included in a node to be embedded, MASK has 1, otherwise, MASK has 0. MASK has whether to include the node for the token of the source code so that it has an m-dimension.

$$MASK = \{ \begin{matrix}1 if {t}_{j} ∈ Node , for j = 1 , … , m \\ 0 otherwise\end{matrix} \qquad [ Equation 1 ]$$

Next, as represented in the following Equation 2, the token in the node identified by the MASK is computed with a trainable weight W and then generates the latent expression 1 of the node via a nonlinear activation function ReLU.

Nodeₑ=ReLU((MASK·tₑ)·W) [Equation 2]

5. Statement Encoder of Node Encoder Module (that is, Second Encoder)

The statement encoder (that is, the second encoder) receives a node latent expression 1 which is an output of process 4 as an input to output a node latent expression 2 which learns structural information of the program dependency graph (PDG). The statement encoder (that is, the second encoder) is based on an encoder of the transformer. At this time, the statement encoder (that is, the second encoder) uses an attention of a graph edge of the program dependency graph (PDG) instead of self-full attention of the transformer. The following Equation 3 is an edge attention equation of the statement encoder. Key(Kₑ), Query(Qₑ), and Value(Vₑ) are a set of node latent expressions 1 of process 4. E_{d} is a data dependent edge of the program dependency graph (PDG) and E_{c} is a control dependent edge of the program dependency graph (PDG). E is an edge including all data and flow dependent information.

$$Attention ( {Q}_{e} , {K}_{e} , {V}_{e} ) = softmax ( \frac{E * {Q}_{e} {K}_{e}^{⊤}}{\sqrt{{d}_{k}}} ) {V}_{e} \qquad [ Equation 3 ]$$

$${e}^{\vert Node \vert \times \vert Node \vert} = {E}_{d} + {E}_{c}$$

### 6. Decoder

The decoder follows a decoder structure of the existing model. However, the decoder receives not only Cₑ which is an output of the existing model encoder (that is, the first encoder), but also a set of node latent expressions 2 which are output of the statement encoder (that is, the second encoder). Cₑ and the node latent expression 2 are connected to be input to the decoder.

The operation according to the exemplary embodiment of the present disclosure may be implemented as a program instruction which may be executed by various computers to be recorded in a computer readable storage medium. The computer readable storage medium indicates an arbitrary medium which participates to provide a command to a processor for execution. The computer readable storage medium may include solely a program command, a data file, and a data structure or a combination thereof. For example, the computer readable medium may include a magnetic medium, an optical recording medium, and a memory. The computer program may be distributed on a networked computer system so that the computer readable code may be stored and executed in a distributed manner. Functional programs, codes, and code segments for implementing the present embodiment may be easily inferred by programmers in the art to which this embodiment belongs.

The present embodiments are provided to explain the technical spirit of the present embodiment and the scope of the technical spirit of the present embodiment is not limited by these embodiments. The protection scope of the present embodiments should be interpreted based on the following appended claims and it should be appreciated that all technical spirits included within a range equivalent thereto are included in the protection scope of the present embodiments.

What is claimed is:

1. An AI based source code summary method using structural information, comprising:
acquiring a source code and a program dependency graph (PDG) corresponding to the source code; and
training a neural network with a source code summary as an output based on the source code and the program dependency graph (PDG).

2. The AI based source code summary method using structural information according to claim 1, wherein the neural network includes:
a first encoder which learns a code sequence based on the source code;
a second encoder which learns a structural characteristic based on the program dependency graph (PDG); and
a decoder which receives an ensemble of an output of the first encoder and an output of the second encoder to generate the source code summary for the source code.

3. The AI based source code summary method using structural information according to claim 2, wherein the first encoder receives token embedding of the source code and outputs a token level latent expression for the source code.

4. The AI based source code summary method using structural information according to claim 3, wherein the second encoder receives the program dependency graph (PDG) and outputs a statement level latent expression for the source code.

5. The AI based source code summary method using structural information according to claim 4, wherein the second encoder uses an attention of a graph edge of the program dependency graph (PDG).

6. The AI based source code summary method using structural information according to claim 5, wherein the decoder receives a value connecting a token level latent expression which is an output of the first encoder and a statement level latent expression which is an output of the second encoder and outputs the source code summary formed of natural language summary.

7. A computer program stored in a computer readable storage medium to allow a computer to execute the AI based source code summary method using structural information according to claim 1.

8. An AI based source code summary apparatus using structural information, comprising:
a memory which stores one or more programs to summary a source code based on the artificial intelligence using structural information of the source code; and
one or more processors which performs an operation to summary the source code based on the artificial intelligence using structural information of the source code according to one or more programs stored in the memory,
wherein the processor is configured to acquire a source code and a program dependency graph (PDG) corresponding to the source code; and train a neural network with a source code summary as an output based on the source code and the program dependency graph (PDG).

9. The AI based source code summary apparatus using structural information according to claim 8, wherein the neural network includes:
a first encoder which learns a code sequence based on the source code;
a second encoder which learns a structural characteristic based on the program dependency graph (PDG); and
a decoder which receives an ensemble of an output of the first encoder and an output of the second encoder to generate the source code summary for the source code.

10. The AI based source code summary apparatus using structural information according to claim 9, wherein the first encoder receives token embedding of the source code and outputs a token level latent expression for the source code.

11. The AI based source code summary apparatus using structural information according to claim 10, wherein the second encoder receives the program dependency graph (PDG) and outputs a statement level latent expression for the source code.

12. The AI based source code summary apparatus using structural information according to claim 11, wherein the decoder receives a value connecting a token level latent expression which is an output of the first encoder and a statement level latent expression which is an output of the second encoder and outputs the source code summary formed of natural language summary.
